(19) United States
(12) Patent Application Publication
(10) Pub. No.: US 2025/0164187 A1
(43) Pub. Date: May 22, 2025

(54) GLASS MELTING FURNACES AND VESSELS WITH IMPROVED THERMAL PERFORMANCE

(71) Applicant: CORNING INCORPORATED, CORNING, NY (US)

(72) Inventors: Bryce Patrick Butler, Elmira, NY (US); Tzu-Hsuan Kao, Taichung City (TW); Boon Hooi Tan, Osaka-shi (JP); Joel David Earl Vice, Lexington, KY (US); Cheng Yi Wu, New Taipei City (TW); Tytus Lee Zimmerman, Columbia Cross Roads, PA (US)

(21) Appl. No.: 18/836,536

(22) PCT Filed: Feb. 17, 2023
(86) PCT No.: PCT/US2023/013264

§ 371 Date: Aug. 7, 2024

Related U.S. Application Data
(60) Provisional application No. 63/313,399, filed on Feb. 24, 2022.

(51) Int. Cl. F27B 3/24; C03B 5/23; C03B 5/26; C03B 5/43; C03B 5/44; F27B 3/19; F27B 3/20; F27D 9/00

(52) U.S. Cl. CPC F27B 3/24; C03B 5/23; C03B 5/26; C03B 5/44; F27B 3/19; F27D 9/00; C03B 5/43; F27B 3/205; F27D 2009/0005

(57) ABSTRACT

Glass melting furnaces include a melting vessel that includes a floor, a feeding mechanism configured to feed raw materials into the melting vessel, a heating mechanism configured to convert raw materials fed into the melting vessel into molten glass, and a cooling mechanism extending within the floor and configured to flow a cooling fluid therethrough.

### CROSS-REFERENCE TO RELATED APPLICATION

This application claims the benefit of priority under 35 U.S.C. § 119 of U.S. Provisional Application Ser. No. 63/313399 filed on Feb. 24, 2022, the content of which is relied upon and incorporated by reference in its entirety.

### FIELD

The present disclosure relates generally to glass melting furnaces and vessels and more particularly to glass melting furnaces and vessels with improved thermal performance.

### BACKGROUND

In the production of glass articles, such as glass sheets for display applications, including televisions and hand-held devices, such as telephones and tablets, a glass composition is typically melted in a melting vessel. During operation of the melting vessel over the course of a production campaign, hot spots can develop in certain areas of the melting vessel, which, over time, may result in degradation of melting vessel materials, eventually causing a phenomenon known as “fire through” wherein mechanical failure of melting vessel material ultimately occurs. Such occurrence can cause significant disruption to a production campaign as well as substantial repair costs. Accordingly, it would be desirable to minimize such occurrence.

### SUMMARY

Embodiments disclosed herein include a glass melting furnace. The glass melting furnace includes a melting vessel that includes a floor. The glass melting furnace also includes a feeding mechanism configured to feed raw materials into the melting vessel. In addition, the glass melting furnace includes a heating mechanism configured to convert raw materials fed into the melting vessel into molten glass. The glass melting furnace also includes a cooling mechanism extending within the floor and configured to flow a cooling fluid therethrough.

Embodiments disclosed herein also include a method of operating a glass melting furnace. The method includes feeding raw materials into a melting vessel. The method also includes converting the raw materials fed into the melting vessel into molten glass. In addition, the method includes flowing a cooling fluid through a cooling mechanism extending within a floor of the melting vessel.

Additional features and advantages of the embodiments disclosed herein will be set forth in the detailed description which follows, and in part will be readily apparent to those skilled in the art from that description or recognized by practicing the disclosed embodiments as described herein, including the detailed description which follows, the claims, as well as the appended drawings.

It is to be understood that both the foregoing general description and the following detailed description present embodiments intended to provide an overview or framework for understanding the nature and character of the claimed embodiments. The accompanying drawings are included to provide further understanding, and are incorporated into and constitute a part of this specification. The drawings illustrate various embodiments of the disclosure, and together with the description explain the principles and operations thereof.

### BRIEF DESCRIPTION OF THE DRAWINGS

FIG. 1 is a schematic view of an example fusion down draw glass-making apparatus and process;

FIG. 2 is a schematic side cutaway view of an example glass melting vessel in accordance with embodiments disclosed herein;

FIG. 3 is schematic top cutaway view of the example glass melting vessel of FIG. 2;

FIG. 4 is schematic end cutaway view of the example glass melting vessel of FIGS. 2-3;

FIG. 5 is a schematic bottom cutaway view of the example glass melting vessel of FIGS. 2-4; and

FIG. 6 is a schematic side cutaway view of a floor of an example glass melting vessel in accordance with embodiments disclosed herein.

### DETAILED DESCRIPTION

Reference will now be made in detail to embodiments of the present disclosure, examples of which are illustrated in the accompanying drawings. Whenever possible, the same reference numerals will be used throughout the drawings to refer to the same or like parts. However, this disclosure may be embodied in many different forms and should not be construed as limited to the embodiments set forth herein.

Ranges can be expressed herein as from “about” one particular value, and/or to “about” another particular value. When such a range is expressed, another embodiment includes from the one particular value and/or to the other particular value. Similarly, when values are expressed as approximations, for example by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

As used herein, the term “heating mechanism” refers to a mechanism that provides heat to a glass melting furnace and/or melting vessel, such as through the operation of electrodes, combustion burners, or both.

As used herein, the term “cooling mechanism” refers to a mechanism that removes heat from a glass melting furnace and/or melting vessel, such at through at least one of convection, conduction, or radiation.

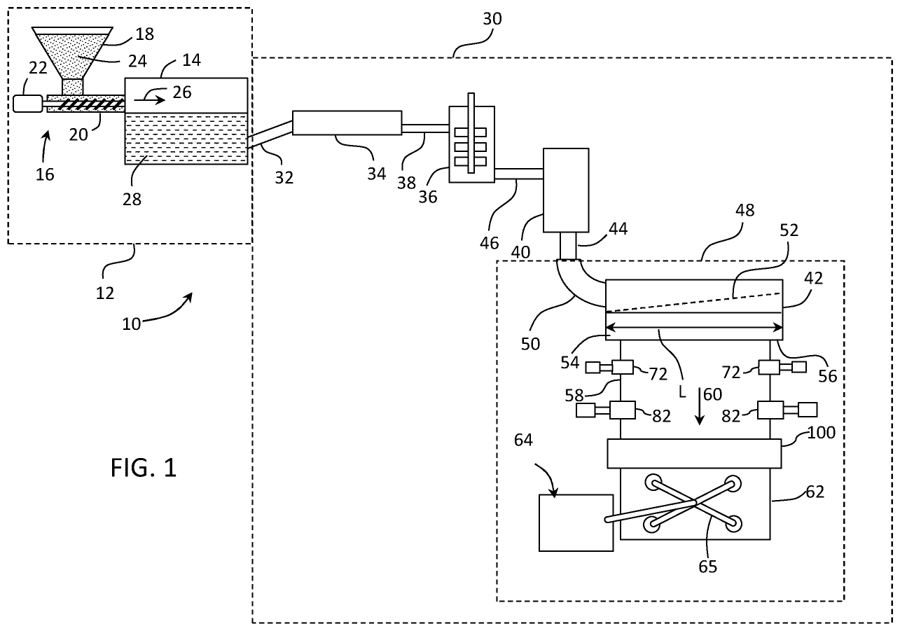

Shown in FIG. 1 is an exemplary glass manufacturing apparatus 10. In some examples, the glass manufacturing apparatus 10 can comprise a glass melting furnace 12 that can include a melting vessel 14. Glass melting furnace 12 including melting vessel 14 can include one or more additional components such as heating elements or mechanisms (e.g., combustion burners or electrodes) that heat raw materials and convert the raw materials into molten glass. In further examples, glass melting furnace 12 may include thermal management devices (e.g., insulation components) that reduce heat lost from a vicinity of the melting vessel. In still further examples, glass melting furnace 12 may include electronic devices and/or electromechanical devices that facilitate melting of the raw materials into a glass melt. Still further, glass melting furnace 12 may include support structures (e.g., support chassis, support member, etc.) or other components.

Glass melting vessel 14 is typically comprised of refractory material, such as a refractory ceramic material, for example a refractory ceramic material comprising alumina or zirconia. In some examples glass melting vessel 14 may be constructed from refractory ceramic bricks. Specific embodiments of glass melting vessel 14 will be described in more detail below.

In some examples, the glass melting furnace may be incorporated as a component of a glass manufacturing apparatus to fabricate a glass substrate, for example a glass ribbon of a continuous length. In some examples, the glass melting furnace of the disclosure may be incorporated as a component of a glass manufacturing apparatus comprising a slot draw apparatus, a float bath apparatus, a down-draw apparatus such as a fusion process, an up-draw apparatus, a press-rolling apparatus, a tube drawing apparatus or any other glass manufacturing apparatus that would benefit from the aspects disclosed herein. By way of example, FIG. 1 schematically illustrates glass melting furnace 12 as a component of a fusion down-draw glass manufacturing apparatus 10 for fusion drawing a glass ribbon for subsequent processing into individual glass sheets.

The glass manufacturing apparatus 10 (e.g., fusion down-draw apparatus 10) can optionally include an upstream glass manufacturing apparatus 16 that is positioned upstream relative to glass melting vessel 14. In some examples, a portion of, or the entire upstream glass manufacturing apparatus 16, may be incorporated as part of the glass melting furnace 12.

As shown in the illustrated example, the upstream glass manufacturing apparatus 16 can include a storage bin 18, a raw material delivery device 20 and a motor 22 connected to the raw material delivery device. Storage bin 18 may be configured to store a quantity of raw materials 24 that can be fed into melting vessel 14 of glass melting furnace 12, as indicated by arrow 26. Raw materials 24 typically comprise one or more glass forming metal oxides and one or more modifying agents. In some examples, raw material delivery device 20 can be powered by motor 22 such that raw material delivery device 20 delivers a predetermined amount of raw materials 24 from the storage bin 18 to melting vessel 14. In further examples, motor 22 can power raw material delivery device 20 to introduce raw materials 24 at a controlled rate based on a level of molten glass sensed downstream from melting vessel 14. Raw materials 24 within melting vessel 14 can thereafter be heated to form molten glass 28.

Glass manufacturing apparatus 10 can also optionally include a downstream glass manufacturing apparatus 30 positioned downstream relative to glass melting furnace 12. In some examples, a portion of downstream glass manufacturing apparatus 30 may be incorporated as part of glass melting furnace 12. In some instances, first connecting conduit 32 discussed below, or other portions of the downstream glass manufacturing apparatus 30, may be incorporated as part of glass melting furnace 12. Elements of the downstream glass manufacturing apparatus, including first connecting conduit 32, may be formed from a precious metal. Suitable precious metals include platinum group metals selected from the group of metals consisting of platinum, iridium, rhodium, osmium, ruthenium and palladium, or alloys thereof. For example, downstream components of the glass manufacturing apparatus may be formed from a platinum-rhodium alloy including from about 70 to about 90% by weight platinum and about 10% to about 30% by weight rhodium. However, other suitable metals can include molybdenum, palladium, rhenium, tantalum, titanium, tungsten and alloys thereof.

Downstream glass manufacturing apparatus 30 can include a first conditioning (i.e., processing) vessel, such as fining vessel 34, located downstream from melting vessel 14 and coupled to melting vessel 14 by way of the above-referenced first connecting conduit 32. In some examples, molten glass 28 may be gravity fed from melting vessel 14 to fining vessel 34 by way of first connecting conduit 32. For instance, gravity may cause molten glass 28 to pass through an interior pathway of first connecting conduit 32 from melting vessel 14 to fining vessel 34. However, other conditioning vessels may be positioned downstream of melting vessel 14, for example between melting vessel 14 and fining vessel 34. In some embodiments, a conditioning vessel may be employed between the melting vessel and the fining vessel wherein molten glass from a primary melting vessel is further heated to continue the melting process or cooled to a temperature lower than the temperature of the molten glass in the melting vessel before entering the fining vessel.

Bubbles may be removed from molten glass 28 within fining vessel 34 by various techniques. For example, raw materials 24 may include multivalent compounds (i.e. fining agents) such as tin oxide that, when heated, undergo a chemical reduction reaction and release oxygen. Other suitable fining agents include without limitation arsenic, antimony, iron and cerium. Fining vessel 34 is heated to a temperature greater than the melting vessel temperature, thereby heating the molten glass and the fining agent. Oxygen produced by the temperature-induced chemical reduction of the fining agent(s) can diffuse or coalesce into bubbles produced in the molten glass during the melting process. The enlarged gas bubbles can then rise to a free surface of the molten glass in the fining vessel and thereafter be vented out of the fining vessel. The bubbles can further induce mechanical mixing of the molten glass in the fining vessel.

Downstream glass manufacturing apparatus 30 can further include another conditioning vessel such as a mixing vessel 36 for mixing the molten glass. Mixing vessel 36 may be located downstream from the fining vessel 34. Mixing vessel 36 can be used to provide a homogenous glass melt composition, thereby reducing cords of chemical or thermal inhomogeneity that may otherwise exist within the fined molten glass exiting the fining vessel. As shown, fining vessel 34 may be coupled to mixing vessel 36 by way of a second connecting conduit 38. In some examples, molten glass 28 may be gravity fed from the fining vessel 34 to mixing vessel 36 by way of second connecting conduit 38. For instance, gravity may cause molten glass 28 to pass through an interior pathway of second connecting conduit 38 from fining vessel 34 to mixing vessel 36. While mixing vessel 36 is shown downstream of fining vessel 34, mixing vessel 36 may be positioned upstream from fining vessel 34. In some embodiments, downstream glass manufacturing apparatus 30 may include multiple mixing vessels, for example a mixing vessel upstream from fining vessel 34 and a mixing vessel downstream from fining vessel 34. These multiple mixing vessels may be of the same design, or they may be of different designs.

Downstream glass manufacturing apparatus 30 can further include another conditioning vessel such as delivery vessel 40 that may be located downstream from mixing vessel 36. Delivery vessel 40 may condition molten glass 28 to be fed into a downstream forming device. For instance, delivery vessel 40 can act as an accumulator and/or flow controller to adjust and/or provide a consistent flow of molten glass 28 to forming body 42 by way of exit conduit 44. As shown, mixing vessel 36 may be coupled to delivery vessel 40 by way of third connecting conduit 46. In some examples, molten glass 28 may be gravity fed from mixing vessel 36 to delivery vessel 40 by way of third connecting conduit 46. For instance, gravity may drive molten glass 28 through an interior pathway of third connecting conduit 46 from mixing vessel 36 to delivery vessel 40.

Downstream glass manufacturing apparatus 30 can further include forming apparatus 48 comprising the above-referenced forming body 42 and inlet conduit 50. Exit conduit 44 can be positioned to deliver molten glass 28 from delivery vessel 40 to inlet conduit 50 of forming apparatus 48. For example, exit conduit 44 may be nested within and spaced apart from an inner surface of inlet conduit 50, thereby providing a free surface of molten glass positioned between the outer surface of exit conduit 44 and the inner surface of inlet conduit 50. Forming body 42 in a fusion down draw glass-making apparatus can comprise a trough 52 positioned in an upper surface of the forming body 42 and converging forming surfaces 54 that converge in a draw direction along a bottom edge 56 of the forming body 42. Molten glass delivered to the forming body trough via delivery vessel 40, exit conduit 44 and inlet conduit 50 overflows side walls of the trough and descends along the converging forming surfaces 54 as separate flows of molten glass. The separate flows of molten glass join below and along bottom edge 56 to produce a single ribbon of glass 58 that is drawn in a draw or flow direction 60 from bottom edge 56 by applying tension to the glass ribbon, such as by gravity, edge rolls 72 and pulling rolls 82, to control the dimensions of the glass ribbon as the glass cools and a viscosity of the glass increases. Accordingly, glass ribbon 58 goes through a visco-elastic transition and acquires mechanical properties that give the glass ribbon 58 stable dimensional characteristics. Glass ribbon 58 may, in some embodiments, be separated into individual glass sheets 62 by a glass separation apparatus 100 in an elastic region of the glass ribbon. A robot 64 may then transfer the individual glass sheets 62 to a conveyor system using gripping tool 65, whereupon the individual glass sheets may be further processed.

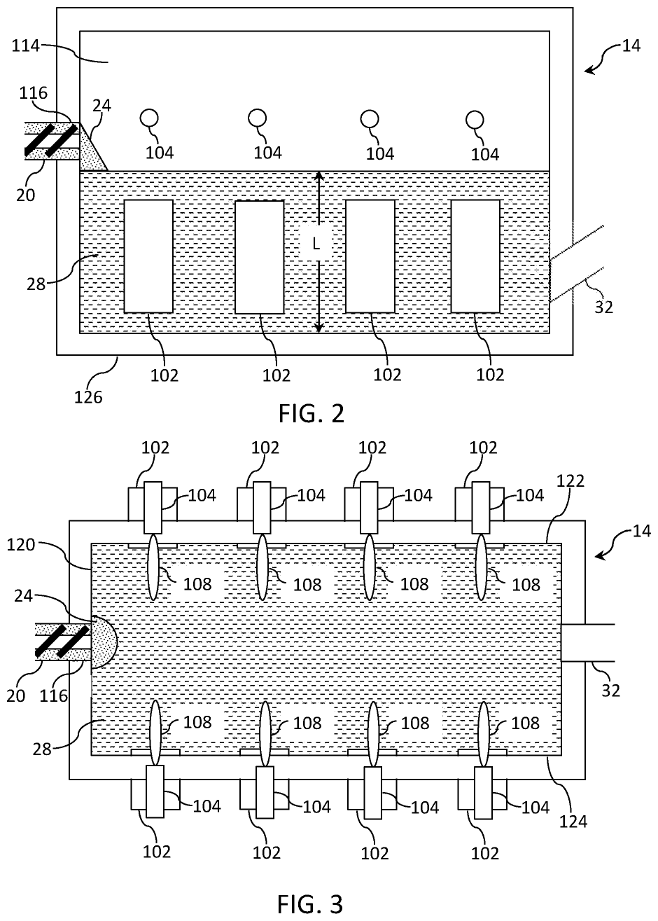

FIG. 2 shows a schematic side cutaway view of an example glass melting vessel 14 in accordance with embodiments disclosed herein. Glass melting vessel 14 includes a chamber 114 positioned above a floor 126, wherein raw material delivery device 20 delivers a predetermined amount of raw batch materials 24 into the chamber 114 through feed port 116, wherein combination of raw material delivery device 20 and feed port 116 comprises a feeding mechanism. Glass melting vessel 14 also includes a plurality of electrodes 102 and a plurality of combustion burners 104.

In operation, plurality of electrodes 102 and plurality of combustion burners 104 heat chamber 114 such that raw batch materials 24 are melted into molten glass 28 up to a predetermined level (L) within chamber 114. As can be seen in FIG. 2, plurality of combustion burners 104 are positioned above the predetermined level (L) and plurality of electrodes 102 are positioned below the predetermined level (L).

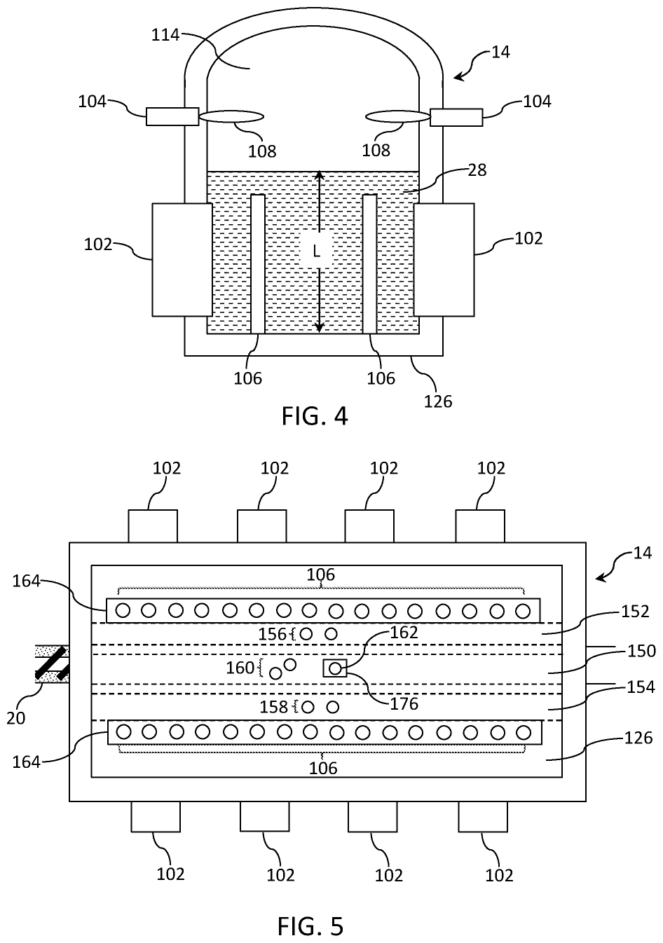

FIGS. 3 and 4, show, respectively, schematic top and end cutaway views of the example glass melting vessel 14 of FIG. 2. As can be seen in FIGS. 3 and 4, each combustion burner 104 emits a flame 108 into the chamber 114. In addition, as shown in FIG. 3, feed port 116 is positioned on a first wall 120 of the chamber 114 and the plurality of combustion burners 104 are positioned on second and third walls 122, 124 of the chamber 114, the second and third walls 122, 124 each extending in directions that are generally parallel to each other and generally perpendicular to the first wall 120. First, second, and third walls, 120, 122, and 124 are also generally perpendicular to floor 126.

As shown in FIG. 4, glass melting vessel 14 includes electrodes 106 extending from floor 126, wherein electrodes 106 are positioned below the predetermined level (L). As further shown in FIG. 4, combustion burners 104 emit flames 108 in a direction that is generally parallel to predetermined level (L).

While FIGS. 2-4, show a glass melting vessel 14 that includes electrodes 102 extending from walls of chamber 114, electrodes 106 extending from floor 126, and combustion burners 104, embodiments disclosed herein can include those in which glass melting vessel 14 does not include one or more of these components. Collectively, one or more of these components comprise a heating mechanism.

In certain exemplary embodiments, electrodes 102 and/or electrodes 106 comprise at least one of tin oxide or molybdenum. In certain exemplary embodiments, electrodes 102 comprise tin oxide and electrodes 106 comprise molybdenum.

FIG. 5 shows a schematic bottom cutaway view of the example glass melting vessel 14 of FIGS. 2-4. As shown in FIG. 5, electrodes 106 extending from floor 126 comprise a plurality of electrodes 106 extending along linear lengths of glass melting vessel 14 and secured in place by electrode holders 164. Glass melting vessel 14 also includes a cooling mechanism comprising first, second, and third channels, 150, 152, 154 extending within floor 126, each channel configured to receive a cooling fluid therethrough. Two orifices 160 are configured to receive cooling fluid into first channel 150, two orifices 156 are configured to receive cooling fluid into second channel 152, and two orifices 158 are configured to receive cooling fluid into third channel 154.

As further shown in FIG. 5, two orifices 160 configured to receive cooling fluid into first channel 150 are diagonally offset relative to a longitudinal length of first channel 150, whereas two orifices 156 and 158 respectively configured to receive cooling fluid into second and third channels 152 and 154 are linearly offset along respective longitudinal lengths of second and third channels 152 and 154. Such configuration can enable improved heat extraction from glass melting vessel 14.

As additionally shown in FIG. 5, glass melting vessel 14 includes a drain 162 and a sealing mechanism 176. Drain 162 facilitates removal of molten glass 28 from glass melting vessel 14 and sealing mechanism 176 prevents or mitigates undesirable fluid flow to or from drain 162. In certain exemplary embodiments, sealing mechanism 176 may comprise a glass plate comprising fused silica.

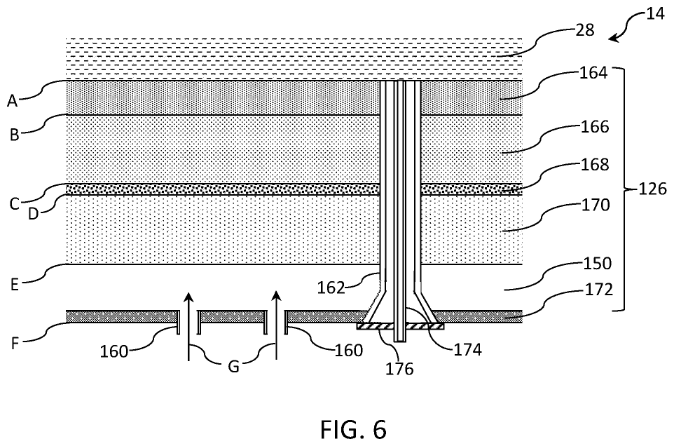

FIG. 6 shows a schematic side cutaway view of a floor 126 of an example glass melting vessel 14 in accordance with embodiments disclosed herein. As shown in FIG. 6, drain 162 extends through floor 126 and sealing mechanism 176 surrounds at least a portion of drain 162, specifically proximate to an exit portion of drain 162 near the bottom of floor 126. Drain 162 comprises central flow passage 174 for flowing molten glass 28 therethrough.

As further shown in FIG. 6, floor 126 includes a plurality of layers. Specifically, floor 126 comprises a plurality of refractory layers, such as refractory ceramic layers, which extend between molten glass 28 and the cooling mechanism comprising, e.g., first channel 150. Floor also comprises metal layer 172 through which orifices 160 extend.

Plurality of refractory layers include molten glass contact layer 164, sublayer 166, leveling layer 168, and lower insulating layer 170. And while FIG. 6 shows four refractory layers extending between molten glass 28 and cooling mechanism, embodiments disclosed herein include those comprising more or fewer refractory layers extending between molten glass 28 and cooling mechanism.

In certain exemplary embodiments, glass contact layer 164 comprises zirconia, such as fused zirconia, including CZ-type fused zirconia, magnesia calcium zirconia (MCZ), or Xilec 9 available from Sefpro. In certain exemplary embodiments, sublayer 166 comprises alumina. In certain exemplary embodiments, leveling layer 168 comprises a high alumina sand mixture. In certain exemplary embodiments, lower insulating layer 170 comprises an alumina and silica-containing material, such as a high-alumina mullite brick material, including TAMAX® high alumina (70%), high-purity mullite brick material available from Harbison Walker International (HWI). In certain exemplary embodiments, metal layer 172 comprises steel.

Embodiments disclosed herein include those in which temperature measurements may be taken at various locations or depths within floor 126 during operation of glass melting furnace 12. Exemplary temperature measurement locations are shown as A-F in FIG. 6. Such temperature measurements may be made using thermocouples or other temperature measurement devices known to persons having ordinary skill in the art.

In certain exemplary embodiments, during operation of glass melting furnace 12, a temperature at an interface of molten glass 28 and glass contact layer 164 (shown as “A” in FIG. 6) may range from about 1600° C. to about 1650° C., a temperature at an interface of glass contact layer 164 and sublayer 166 (shown as “B” in FIG. 6) may range from about 1380° C. to about 1430° C., a temperature at an interface of sublayer 166 and leveling layer 168 (shown as “C” in FIG. 6) may range from about 1100° C. to about 1150° C., a temperature at an interface of leveling layer 168 and lower insulating layer 170 (shown as “D” in FIG. 6) may range from about 970° C. to about 1020° C., a temperature at an interface of lower insulating layer 170 and first channel 150 (shown as “E” in FIG. 6) may range from about 150° C. to about 200° C., and a temperature at outer (or bottom) edge of metal layer 172 (shown as “F” in FIG. 6) may range from about 75° C. to about 125° C.

In certain exemplary embodiments, a temperature difference between an interface of molten glass 28 and glass contact layer 164 and an interface of glass contact layer 164 and sublayer 166 (i.e., A-B) may range from about 200° C. to about 250° C., such as from about 215° C. to about 235° C. In certain exemplary embodiments, a temperature difference between an interface of molten glass 28 and glass contact layer 164 and an interface of lower insulating layer 170 and first channel 150 (i.e., A-E) may range from about 1400° C. to about 1500° C., such as from about 1425° C. to about 1475° C. In certain exemplary embodiments, a temperature difference between an interface of molten glass 28 and glass contact layer 164 and a temperature at outer (or bottom) edge of metal layer 172 (i.e., A-F) may range from about 1500° C. to about 1600° C., such as from about 1525° C. to about 1575° C.

During operation of glass melting furnace 12, a cooling fluid, such as a gaseous cooling fluid, may be flowed into cooling mechanism, such as into one or more of first, second, and third channels, 150, 152, 154. For example, as shown in FIG. 6, a cooling fluid may be flowed into first channel 150 from a fluid source, such as a fluid pump or fan (not shown), through orifices 160 as shown by arrows “G.” Once flowed into first channel 150, portions of the cooling fluid may be flowed toward opposite longitudinal ends of first channel 150 and may exit first channel through an exhaust vent or exit orifice (not shown). In a similar manner, cooling fluid may also be flowed into second and third channels 152 and 154 via orifices 156 and 158 respectively.

In certain exemplary embodiments, the cooling fluid comprises air. In certain exemplary embodiments, a temperature of cooling fluid flowed into one or more of first, second, and third channels, 150, 152, 154 via orifices 160, 156, and 158 may range from about 25° C. to about 50° C. In certain exemplary embodiments, a diameter of first, second, and/or third channels, 150, 152, 154 may range from about 1 inch to about 5 inches, such as from about 2 inches to about 4 inches.

Embodiments disclosed herein can enable greater heat flux through floor 126 of glass melting vessel 14, which can, in turn, enable improved electrical resistivity of floor 126 and specifically, improved electrical resistivity of glass contact layer 164. For example, embodiments disclosed herein can enable at least about 10% more heat flux, such as at least about 15% more heat flux, including from about 10% to about 20% more heat flux through floor 126 of glass melting vessel 14 as compared to a melting vessel 14 that does not comprise cooling mechanisms as described herein, including a cooling mechanism extending within the floor 14 and configured to flow a cooling fluid therethrough and wherein the cooling mechanism comprises a first channel 150 configured to receive a cooling fluid therethrough and at least two orifices 160 configured to receive the cooling fluid into the first channel 150.

Embodiments disclosed herein can also, for example, enable at least about 5%, such as at least about 10%, such as from about 5% to about 25% greater electrical resistivity of floor 126 (or portion of floor 126 such as glass contact layer 164, sublayer 166, leveling layer 168, and/or lower insulating layer 170) at a given temperature and production campaign duration as compared to a melting vessel 14 that does not comprise cooling mechanisms as described herein, including a cooling mechanism extending within the floor 14 and configured to flow a cooling fluid therethrough and wherein the cooling mechanism comprises a first channel 150 configured to receive a cooling fluid therethrough and at least two orifices 160 configured to receive the cooling fluid into the first channel 150.

Such increased heat flux and electrical resistivity can, in turn, enable glass melting furnaces 12 and/or glass melting vessels 14 wherein the occurrence of fire through is mitigated or delayed (thereby extending the service life of the melting furnaces 12 and/or melting vessels 14), such as delayed by a period of at least about a year during a production campaign, as compared to a melting vessel 14 that does not comprise cooling mechanisms as described herein, including a cooling mechanism extending within the floor 14 and configured to flow a cooling fluid therethrough and wherein the cooling mechanism comprises a first channel 150 configured to receive a cooling fluid therethrough and at least two orifices 160 configured to receive the cooling fluid into the first channel 150.

While the above embodiments have been described with reference to fusion down draw processes, it is to be understood that such embodiments are also applicable to other glass forming processes, such as slot draw processes, float processes, up-draw processes, and press-rolling processes.

Such processes can be used to make glass articles, which can be used, for example, in electronic devices as well as for other applications.

It will be apparent to those skilled in the art that various modifications and variations can be made to embodiments of the present disclosure without departing from the spirit and scope of the disclosure. Thus, it is intended that the present disclosure cover such modifications and variations provided they come within the scope of the appended claims and their equivalents.

What is claimed is:

1. A glass melting furnace comprising:
a melting vessel comprising a floor;
a feeding mechanism configured to feed raw materials into the melting vessel;
a heating mechanism configured to convert raw materials fed into the melting vessel into molten glass; and
a cooling mechanism extending within the floor and configured to flow a cooling fluid therethrough.

2. The glass melting furnace of claim 1, wherein the cooling mechanism comprises a first channel configured to receive a cooling fluid therethrough and at least two orifices configured to receive the cooling fluid into the first channel.

3. The glass melting furnace of claim 2, wherein the cooling mechanism comprises second and third channels that are each configured to flow a cooling fluid therethrough and are each generally parallel to the first channel.

4. The glass melting furnace of claim 2, wherein the floor comprises a metal layer through which the orifices extend.

5. The glass melting furnace of claim 1, wherein the heating mechanism comprises at least one electrode extending from the floor.

6. The glass melting furnace of claim 1, wherein the melting vessel comprises a drain that extends through the floor and a sealing mechanism surrounding at least a portion of the drain.

7. The glass melting furnace of claim 1, wherein the floor comprises at least one refractory ceramic layer extending between the molten glass and the cooling mechanism.

8. The glass melting furnace of claim 1, wherein the cooling fluid comprises gas.

9. A method of operating a glass melting furnace comprising:
feeding raw materials into a melting vessel;
converting the raw materials fed into the melting vessel into molten glass; and
flowing a cooling fluid through a cooling mechanism extending within a floor of the melting vessel.

10. The method of claim 9, wherein the cooling fluid flows into a first channel of the cooling mechanism through at least two orifices.

11. The method of claim 10, wherein the floor comprises a metal layer through which the orifices extend.

12. The method of claim 10, wherein the cooling fluid flows through second and third channels that are each generally parallel to the first channel.

13. The method of claim 9 comprising operating a heating mechanism that comprises at least one electrode extending from the floor.

14. The method of claim 9, wherein the melting vessel comprises a drain that extends through the floor and a sealing mechanism surrounding at least a portion of the drain.

15. The method of claim 1, wherein the floor comprises at least one refractory ceramic layer extending between the molten glass and the cooling mechanism.

16. The method of claim 1, wherein the cooling fluid comprises air.
